(19) United States
(12) Patent Application Publication
(10) Pub. No.: US 2022/0382836 A1
(43) Pub. Date: Dec. 1, 2022

(54) ELECTRONIC AUTHENTICATION METHOD

(71) Applicant: Ismet YESIL, Umraniye/Istanbul (TR)

(72) Inventor: Ismet YESIL, Umraniye/Istanbul (TR)

(21) Appl. No.: 17/776,173

(22) PCT Filed: Nov. 2, 2020
(86) PCT No.: PCT/TR2020/051023

§ 371 Date: May 11, 2022

(30) Foreign Application Priority Data
Nov. 11, 2019 (TR) 2019/17482

(51) Int. Cl. G06F 21/31

(52) U.S. Cl. CPC G06F 21/31

(57) ABSTRACT

The present invention relates to a method comprising the steps of sending random or pseudo-random information to a display unit of an electronic device, inputting information to a data entry unit of an electronic device by a user using random or pseudo-random information in accordance with a predetermined rule, checking whether the information entered matches to information which is previously stored in a memory unit, and authenticating of the user in case that the information entered by the user matches to the information which is previously registered in the memory.

### TECHNICAL FIELD

The present invention relates to an electronic authentication method with an improved security.

### BACKGROUND OF THE INVENTION

Electronic authentication methods are substantially carried out depending on personal biometric data or data in a person's memory. In both methods, a data entry device is used to receive personal data, and the data received via this data entry device are compared with the data previously registered in a memory unit.

Although a biometric authentication method does not require persons to remember a verification information from their memory, the data entry devices cannot detect the biometric data with sufficient precision. An algorithmic performance of the data entry devices based on retina or fingerprint data, for instance, is still not at the desired level, since the precision of the data received from a user while being recorded in a memory of an authentication computer may not be retained when receiving the data subsequently, thus the user may be repeatedly asked to enter data (to have his/her retina or fingerprint read) since the authentication cannot be provided.

Various problems are also encountered in systems where a person performs an authentication process using information in his/her memory. A widely-known practice includes entering a (usually) 4-digit number (Personal Identification Number—PIN) used by the individuals accessing to their bank accounts. In this practice, a two-step security procedure is used, but it is known that this is not secure enough. In the first step, interbank authorization requests are sent from a data entry unit via a card in which information is contained, such as user account information, date of expiry, card number, etc., and when this step is completed, the second step is proceeded, wherein a user is asked to enter PIN on the terminal. The transaction, e.g. payment process, is completed when both steps are validated.

According to the example above, the first step is essentially based on validation of the static information stored in an object, and the second step is based on validation of the static information (PIN) on the user's memory. In fact, the user's PIN may be changed by the user with the one registered in a host computer memory, however, this is not a dynamic change. In this case, unauthorized persons who obtain the information on the fixed object (on the card), and the user's PIN, may enter the user accounts and perform funds transfer. Examples of such frauds are frequently observed in various countries around the world in the form of ATM card cloning, or cloning over POS devices.

### BRIEF DESCRIPTION OF THE INVENTION

The object of the invention is to provide an electronic authentication method with an improved security.

In order to achieve the object, the present invention provides a method comprising the steps of sending random or pseudo-random information to a display unit of an electronic device,

entering information to a data entry unit of an electronic device by a user optionally using random or pseudo-random information in accordance with a predetermined rule,
checking whether the information entered matches to information in a memory unit, and authenticating of the user in case that the information entered by the user matches to the information in the memory unit.

According to an embodiment of the invention, the information in the memory unit is pre-recorded information, or information created at that moment according to said predetermined rule.

According to an embodiment of the invention, random or pseudo-random information comprises one or more numerical information.

According to an embodiment of the invention, random or pseudo-random information partly or fully comprises a particular order of the information in the memory unit.

According to an embodiment of the invention, the information in the memory unit may optionally be changed by a user. According to an embodiment of the invention, information in the memory unit may be changed by selecting a rule in a pre-recorded set of rules.

According to an embodiment of the invention, the electronic device comprises a memory unit. According to an embodiment of the invention, a second electronic device communicating with the electronic device comprises said memory.

According to a second embodiment of the invention, the first electronic device may be a wired or wireless terminal device located in a local or wide area communication network, in particular a personal computer, a smartphone, a tablet, a POS device, or an ATM, etc. According to the second embodiment of the invention, the second electronic device may be a host computer.

In one aspect, the invention relates to a computer program product comprising instructions which, when a program is run by a computer, enables the computer to perform the above-mentioned method steps.

In one aspect, the invention relates to a computer-readable storage medium comprising instructions which, when executed by a computer, enables the computer to perform the above-mentioned method steps.

### BRIEF DESCRIPTION OF THE DRAWINGS

FIG. 1 is a representative view of a door access control device according to the invention.

FIG. 2 is a representative view of a smartphone which communicates over the Internet and a host computer of a bank.

### DESCRIPTION OF THE PARTS IN THE DRAWINGS

| | |
|---|---|
| 1 | Access control device |
| 2 | Screen |
| 3 | Key pad |
| 4 | Screen information |
| 5 | Door |
| 6 | Information input field |
| 7 | Smartphone |
| 8 | Phone screen |
| 9 | Phone screen information |
| 10 | Information input field of the phone |
| 11 | Key pad of the phone |
| 12 | Host computer |

### DETAILED DESCRIPTION OF THE INVENTION

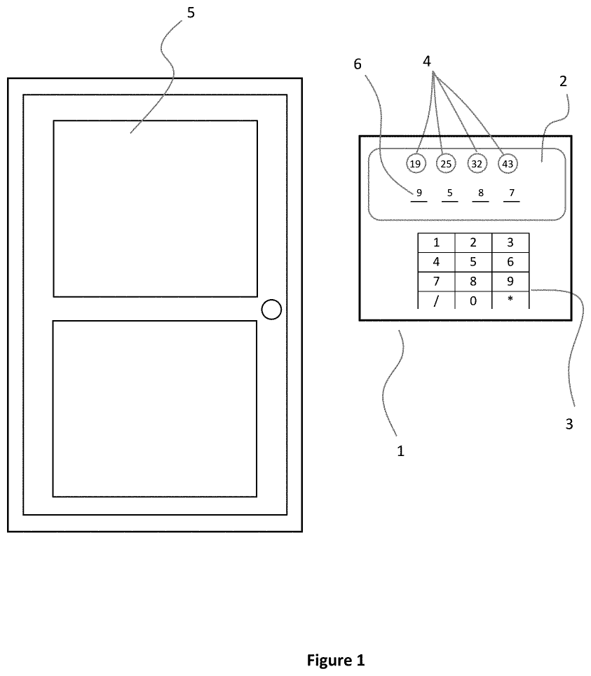

An exemplary implementation of the authentication method according to the invention may be realized with an arrangement that allows access from a door (5) as seen in FIG. 1. An access control device (1) is arranged on a side of the door (5). The access control device (1) comprises a screen (2) and a key pad (3) arranged below it. The access control device (1) is electrically coupled to a drive unit (not shown in the drawing) which may open and close the door (5) (or the lock thereof).

A user may activate the access control device (1) in various ways: For instance, the user may scan (with contact, or contactless) a card with information such as user number, name-surname, title, etc. through the access control device (1), and it is checked whether he/she is a user registered in the system in the first step. Alternatively, it may be sufficient for the user to press a certain key (e.g. the “*” key) or a key combination on the keypad (3) for the first step. In a subsequent step, an authentication process may be performed. To achieve this, random or pseudo-random information (4) is sent to the screen (2) by an electronic processor such as a micro-controller included in the access control device (1). This screen information (4) may preferably consists of alphanumeric characters.

As seen in FIG. 1, the screen information (4) is given as four number pairs. These numbers may have various digits, e.g. one-, two-, three-, four-digit, etc., and may be in a desired number, for example may be one number with various digits. According to an embodiment of the invention, the user enters information into the information input field (6) on the screen (2), using the keypad (3) based on the screen information (4). The information entered by the user based on the screen information (4) is made according to a predetermined rule. This rule may be changed at any time and optionally from a predetermined set of rules. This set of rules is pre-recorded in the memory of the access control device (1). The elements of said set of rules may comprise predetermined static rules, but also a dynamic element so that the user defines a rule desired.

The user information entered in the information input field (6) may contain part of the information in the user's memory. For example, 2 digits of a 4-digit PIN provided to the user may be included in the random or pseudo-random screen information (4) according to a certain rule. In an example where the user's PIN is “7387”, only the first two digits may be derived from random or pseudo-random numbers according to a rule, and the last two digits, i.e. “87” according to the example, may be entered in the information input field. According to the example in FIG. 1, the right (units) digits of the first two of the number pairs in the screen information field are “9” and “5”. In this case, if the rule set by the user is that these first digits are replaced by the first two numbers in the PIN and the last two digits are static, then the resulting combination will be “9587” by replacing “9” and “5” by the first two digits in the PIN (i.e., “7” and “3”, respectively) and by leaving last two digits static according to the example. The entry “9587” will be verified as the screen information (4) is known to the micro-controller, and the rule to be applied is known in advance.

Various numbers of rules may be formed. For example, a set of rules indicated below may be defined:

| Rule no | Description of the rule |
|---|---|
| 1 | The screen information consists of 4 two-digit numbers, and the |
| | numbers in the units digit of the first two number pairs are replaced by |
| | the first two digits of the user's PIN, respectively. |
| 2 | The screen information consists of one 10-digit number, and the |
| | second and fifth numbers from the left are replaced by the last two |
| | digits of the user's PIN, respectively. |
| 3 | The screen information consists of 6 2-digit numbers, and 2 number |
| | pairs comprising the number 5 in the units digit from left to right consist |
| | the user's PIN (wherein there is no previously known PIN and is |
| | currently generated). |
| 4 | The screen information consists of one 13-digit number, and the |
| | second, fourth, sixth and eighth numbers from left, respectively consist |
| | the user's PIN (wherein there is no previously known PIN and is |
| | currently generated). |
| 5 | The screen information consists of 5 two-digit numbers, and the |
| | number in the units digit of the fourth number pair from left is replaced |
| | by the last digit of the user's PIN. |
| 6 | The screen information consists of 4 two-digit numbers, and the |
| | number which is obtained by adding 2 to the number in the tens digit |
| | of each number pair consist the user's PIN (wherein there is no |
| | previously known PIN and is currently generated). |
| 7 | The screen information consists of one 8-digit numbers, and the |
| | number which is obtained by subtracting 1 from the first, third, fifth and |
| | seventh numbers from right, respectively consist the user's PIN |
| | (wherein there is no previously known PIN and is currently generated). |
| 8 | The screen information consists of 6 2-digit numbers, and the |
| | combination of the first two digits of the third number pair from left to |
| | right with the two digits of the current hour consists the user's PIN |
| | (wherein there is no previously known PIN and is currently generated). |
| 9 | The screen information consists of 6 2-digit numbers, and also date |
| | and time information are displayed on the screen. The user's PIN is |
| | the result of an arithmetic operation between the date and/or time |
| | and/or year information and the number pairs on the screen. For |
| | example, the current month consists the first two digits of the PIN, and |
| | the number obtained by subtracting the third number pair from the |
| | fourth number pair from left constitutes the last two digits of the PIN |
| | (wherein there is no previously known PIN and is currently generated). |
| 10 | The screen information consists of one 6-digit numbers, and the PIN is |
| | obtained by putting the age of the user's grandchild next to the |
| | numbers in the units and tens digits of this number (wherein there is |
| | no previously known PIN and is currently generated). |
| 11 | The screen information consists of 6 two-digit numbers, and the PIN is |
| | obtained by adding the current month to the first two-digit number from |
| | left to right and the current day to the third number (wherein there is no |
| | previously known PIN and is currently generated). |
| 12 | The screen information consists of 8 two-digit numbers, and the first |
| | two digits of the PIN are obtained by replacing the second two-digit |
| | number from left to right by each other, and the last two digits of the |
| | PIN are obtained by replacing the fourth two-digit number by each |
| | other. For example, when the screen information is 22 35 46 85 99 75 |
| | 23 57, the PIN is “5358” (wherein there is no previously known PIN and |
| | is currently generated). |
| 13 | The screen information consists of 4 two-digit numbers and a word, |
| | and the second number pair from left to right and the first two letters of |
| | the word consist the PIN (wherein there is no previously known PIN |
| | and is currently generated). |

Each rule is defined according to a certain algorithm. For example, the number in the tens digit of the random and pseudo-random numbers on the screen cannot be “9” according to the rule 6 above, as the rule requires the number “2” to be added to this number. Again, for example, the number from which the number “1” will be subtracted should not be “0” according to the rule 7, otherwise the user obtains the number “−1” and this leads to a confusion. As a result, the rules to be determined are generated on the basis of algorithms that will predict the issues that may cause logical errors. Again, for example, the algorithmically random and pseudo-random numbers are displayed on the screen such that the result of the subtraction operation to be performed is prevented from being “0” or a negative number according to the rule 9.

Any rule may be replaced by another one at any time by the user. In addition, the user may optionally define a rule per se. For example, the user may define a rule of performing an arithmetic operation with any number of the random or pseudo-random number displayed on the screen.

According to an embodiment of the invention, the user may enter information to the information input field (6) on the screen (2) using the key pads (3) without considering the screen information (4). Such an event may especially lead the unauthorized people to be confused who try to figure out what rule the user has applied. For this case, representative rules as set forth below may be generated:

| Rule no | Description of the rule |
|---|---|
| 14 | The screen information consists of 8 2-digit numbers, and the first two |
| | digits of the PIN are the age of the user, and the last two digits are day |
| | of the current month (e.g. “02” for the 2^{nd} day). Alternatively, the last |
| | two digits of the PIN may correspond to the current month (wherein |
| | there is no previously known PIN and is currently generated). |
| 15 | The screen information consists of 5 3-digit numbers, and the first two |
| | digits of the user's PIN is the lucky number of the user, and the last two |
| | digits are the day of the current month (e.g. “02” for the 2^{nd} day). |
| | Alternatively, the last two digits of the PIN may correspond to the |
| | current month (wherein there is no previously known PIN and is |
| | currently generated). |

For rule 14 and rule 15, there is no association with the random or pseudo-random numbers displayed on the screen. Randomly, the necessary measures may be taken algorithmically in case that the information displayed on the screen contains a part of the PIN. For example, when the first digit of the PIN is the age of the user, the user's age is prevented from being displayed on the screen among the random or pseudo-random numbers according to the rule 14.

Although the above-mentioned embodiment discloses the opening of a door using an access control device, it may also be applied to various fields. For example, such an access control device may be used to open a safe box containing cash/valuable documents, or to open a car door, or to start an automobile engine. On the other hand, the phrase “access control device” should be understood as any electronic device. For example, operation of devices independently is encompassed, such as cell phone/smartphone, a computer, a military electronic device, etc.

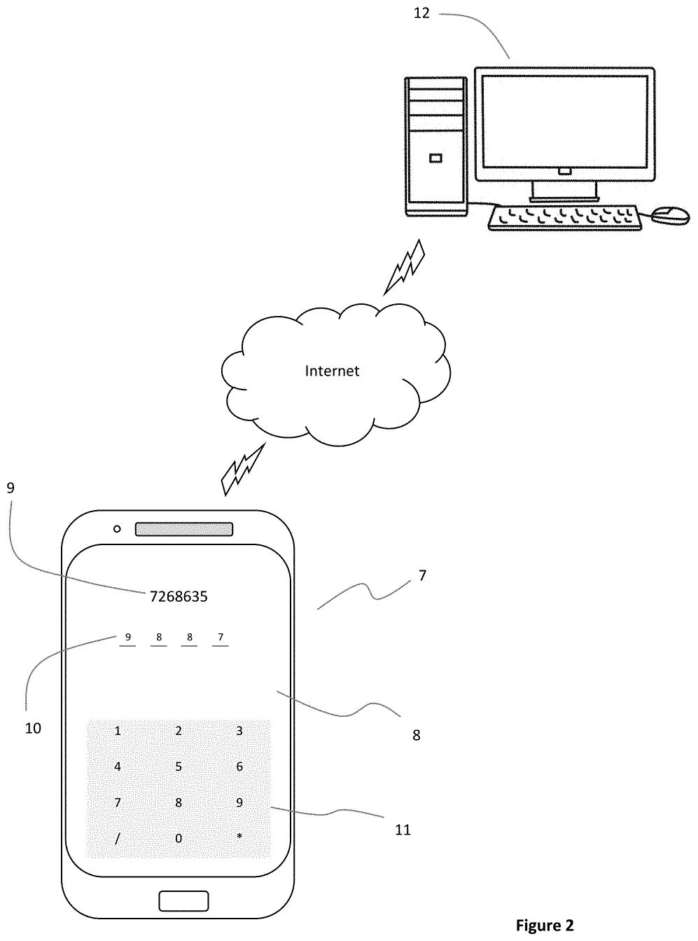

Another implementation of the invention may include an authentication process in a host computer (12) of a bank over the Internet via a smart phone (7), as seen in FIG. 2. Similar to the method described above, in this method, the random or pseudo-random screen information (9) is sent to the phone screen (8).

In such a system, if a substantial part of the authentication process is performed on the smart phone (7) and the result obtained is “correct”, then the user may be allowed to access to the host computer. Alternatively, some of the authentication processes may be performed on the smartphone (7) and some on the host computer (12). According to another alternative, a substantial part of the authentication process may be performed on the host computer (12).

In the case where an essential part of the authentication process is performed on the smartphone (7), the information (9) sent to the phone screen (8) may be obtained via an application/software downloaded on the smartphone (7). The phone application sends random or pseudo-random information (9) to the screen (8), as in the example described above. Unlike the example above, screen information (9) is one 7-digit number. The user may enter information to the information input field (10) on the screen (8) using the key pads (11) based on the screen information (9). Again, the information entered by the user is made according to a predetermined rule (preferably a rule selected from a set of rules). This rule may comprise either a static rule or user-definable dynamic rule of the set of rules.

In case that the selected (valid) rule in the telephone application is a rule of adding the number “2” to the first, third, fifth and seventh numbers of the random or pseudo-random number displayed on the screen from left to right, as shown in FIG. 2, the number to be entered to the information input field of the phone will be “9887”. If the information entered by the user is correct according to the valid rule, the smartphone application may allow the user to have access in the host computer by establishing a secure connection between the smartphone (7) and the host computer (12).

In the case where part of the authentication process is performed on the smartphone (7) and the other part is performed on the host computer (12), the smartphone application sends random or pseudo-random information (9) to the phone screen (8) and creates a secure connection between the smartphone (7) and the host computer (12). The information entered by the user in the information input field (10) according to the valid rule is controlled by the software in the host computer (12), and the user is allowed to access the host computer when the information entered is correct.

In case a substantial part of the authentication process is performed on the host computer (12), the authentication processes are performed on the host computer (12) via the application installed on the smartphone, or via a secure connection of the web browser on the smartphone. That is, the information entered by the user according to the valid rule in response to the random or pseudo-random information (9) displayed on the smartphone screen (8) is controlled on the host computer, and the account is accessed in case that correct information is entered according to the rule.

According to the methods described above, various security protocols may be run in cases where the user does not enter data in accordance with the valid rule. For example, when incorrect data is entered, the random or pseudo-random information may be refreshed, so that the data to be entered is changed. When the number of incorrect data entries is three, for example, a message may be sent to the user's mobile phone/smartphone to inquire whether the person trying to log in is the relevant user. When the user selects “Yes”, information which has been previously recorded in the electronic device, e.g. smartphone according to the example (or in the second electronic device, e.g. the host computer according to the example) may be inquired, such as the first and third letters of the mother's maiden name, or the lucky number of the user, or a temporary password may be sent to the e-mail address of the user. If the user selects “No” during the inquiry, then the user identity will be blocked systematically and preferably for 1-2 hours, thus a notification may be sent that a remote system administrator should be called to execute the required protocols to unblock.

As in the example above, the user may enter information in his/her memory to the information input field (10) on the screen (8) using the key pads (11) without considering the phone screen information (9).

Similar to the communication via a smartphone and a host computer of a bank as described above, the authentication method according to the invention may also be provided between a POS device and the host computer of the bank, or between an ATM and the host computer of the bank.

1. An authentication method characterized by comprising the following steps of:
sending random or pseudo-random information to a display unit of an electronic device, entering information to a data entry unit of an electronic device by a user optionally using random or pseudo-random information in accordance with a predetermined rule, checking whether the information entered matches to information in a memory unit, and authenticating of the user in case that the information entered by the user matches to the information in the memory unit.

2. A method according to claim 1, characterized in that the information in said memory unit is pre-recorded information.

3. A method according to claim 1, characterized in that the information in said memory unit is information created at that moment according to said predetermined rule.

4. A method according to claim 1, characterized in that said rule is an information associated with random or pseudo-random information.

5. A method according to claim 1, characterized in that said rule is an information not associated with random or pseudo-random information.

6. A method according to claim 1, characterized in that the random or pseudo-random information comprises one or more numerical information.

7. A method according to claim 1, characterized in that the random or pseudo-random information partly or fully comprises a particular order of the information which is previously recorded in the memory unit.

8. A method according to claim 1, characterized in that the information which is previously recorded in the memory unit is determined according to a rule in a pre-recorded set of rules.

9. A method according to claim 8, characterized in that said rule is configured to change at any time desired.

10. A method according to claim 8, characterized in that said rule comprises a mathematical arithmetic operation.

11. A method according to claim 1, characterized in that the rule is formed using a variable selected the group consisting of year, minute, month and day.

12. A method according to claim 1, characterized in that said electronic device comprises said memory unit.

13. A method according to claim 1, characterized by comprising a second electronic device having the memory unit, the second electronic device communicating with said electronic device.

14. A method according to claim 12, characterized in that said electronic device is selected from the group consisting of a personal computer, a smartphone, a tablet, or a military electronic device.

15. A method according to claim 13, characterized in that said electronic device is selected from the group consisting of a personal computer, a smartphone, a tablet, a POS device, an ATM, or a military electronic device.

16. A method according to claim 15, characterized in that said second electronic device is a host computer.

17. A method according to claim 1, characterized in that random or pseudo-random information is renewed in case that the information entered by the user is erroneous.

18. A method according to claim 17, characterized in that it comprises the step of sending a message from the memory unit to the user's mobile phone or smart phone in order to verify the user identity after the number of erroneous data entry reaches a certain number.

19. A computer program product, characterized in that it comprises instructions which, when a program is run by a computer, enables the computer to perform the method steps according to claim 1.

20. A computer-readable storage medium, characterized in that it comprises instructions which, when executed by a computer, enables the computer to perform the method steps according to claim 1.
